(19) United States
(12) Patent Application Publication
(10) Pub. No.: US 2010/0073379 A1
(43) Pub. Date: Mar. 25, 2010

(54) METHOD AND SYSTEM FOR RENDERING REAL-TIME SPRITES

(76) Inventors: Sadan Eray Berger, Istanbul (TR); Cemil Sinasi Turun, Istanbul (TR)

Correspondence Address: PERKINS COIE LLP, P.O. BOX 1208, SEATTLE, WA, 98111-1208, US

(21) Appl. No.: 12/237,224

(22) Filed: Sep. 24, 2008

(51) Int. Cl. G06T 15/70; G06F 15/16

(52) U.S. Cl. 345/473; 709/203

(57) ABSTRACT

A method and system for improving rendering performance at a client. The method includes, responsive to an initial request for a first animation sequence at a client, downloading a first 3D object from a server. The method includes rendering the first 3D object into the first animation sequence. The method includes displaying the first animation sequence to a user. The method includes caching the first animation sequence in an accessible memory. The method includes, responsive to a repeat request for the first animation sequence, retrieving the cached first animation sequence from the accessible memory.

### FIELD OF INVENTION

The present invention relates to rendering 3D objects for display in a system without hardware acceleration, and more specifically to caching rendered 3D object meshes to improve performance.

### BACKGROUND

3D rendering is a 3D computer graphics process converting 3D objects into 2D images for display. A 3D object can include animation descriptions, which describes movements and changes in the 3D object over time. Rendering the 3D object produces an animation sequence of 2D images, which show an animation when displayed sequentially.

3D objects can be transmitted as files in a 3D data format, which may represent a 3D mesh and animations of the 3D object. Animation data contains the sequential deformations of the initial mesh. For example, the 3D object can be an avatar in a virtual environment. While 3D files have small memory footprints, a rendered animation sequence can require large amounts of memory. In addition, it can be computationally costly to render an animation sequence from 3D mesh and animation data.

Current applications such as Adobe Flash allow rendering 3D data into animation sequences. For example, such functionality can be provided via Actionscript code. The render is generated into the computer's volatile memory (RAM) for display or later storage. However, Adobe Flash does not support use of a computer platform's hardware acceleration resources. Thus, producing animation sequences require exclusively central processing unit (CPU) time, which can be substantial.

In part due to the CPU costs, it is impossible to render sufficient polygons to display meaningful scenes of 3D objects with animation sequences. Common platforms can only display a maximum of 5000-6000 polygons in real-time, which is insufficient to depict a virtual world room with 10-15 3D characters or avatars.

Thus, there is a need to improve rendering performance of 3D data into animation sequences at a client displaying a virtual 3D environment.

### BRIEF DESCRIPTION OF DRAWINGS

FIG. 1 illustrates an example workstation for improved rendering of 3D objects.

FIG. 2 illustrates an example server for improved rendering of 3D objects.

FIG. 3 illustrates an example system for improved rendering of 3D objects.

FIG. 4A illustrates an example rendered 3D object.

FIG. 4B illustrates an example 3D mesh object.

FIG. 4C illustrates an example animation sequence 420.

FIG. 5 illustrates an example system flow for improved rendering of 3D objects.

FIG. 6 illustrates an example client procedure for improved rendering of 3D objects.

### DETAILED DESCRIPTION

To improve client performance, a rendered animation sequence is cached for future use. In a 3D application with a fixed camera angle, only 3D mesh object animation sequences require rendering. For example, online virtual worlds frequently use an animation sequence repeatedly, such as an avatar walking or gesturing. The 3D mesh object of the avatar and animation sequence can be downloaded from a server and rendered at a client on-demand. After rendering, the client saves the animation sequence in local memory. The next time the client requests the animation sequence, it is retrieved from memory instead of being downloaded and rendered.

Sprites are pre-rendered animation sequences from a number of fixed camera angles used in 3D applications to improve performance. Here, the sprites are rendered at run-time on demand by the 3D application, and are thus “real-time sprites.”

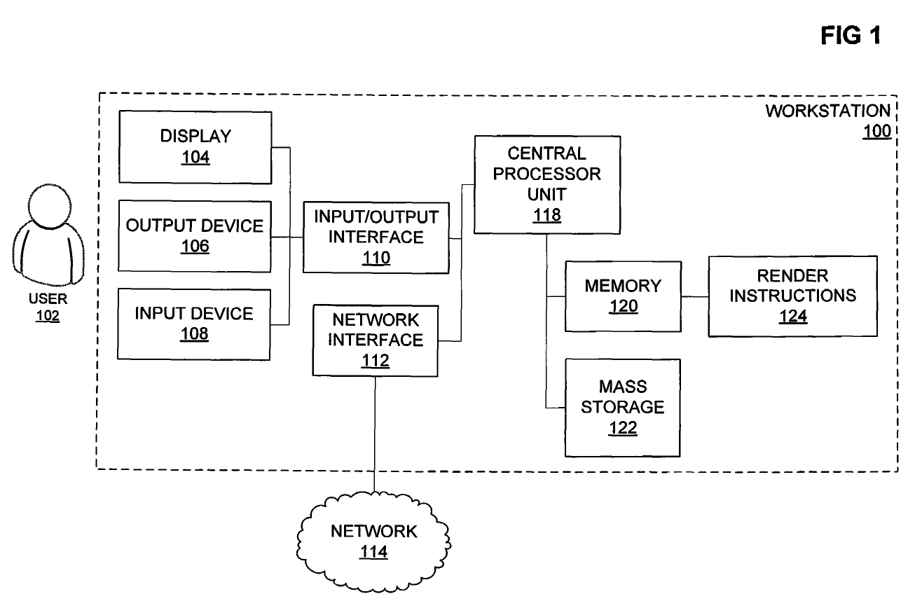

FIG. 1 illustrates an example workstation for improved rendering of 3D objects. The workstation 100 can provide a user interface to a user 102. In one example, the workstation 100 can be configured to communicate with a server over a network and execute a 3D application. For example, the 3D application can be a client for a virtual world provided by the server.

The workstation 100 can be a computing device such as a server, a personal computer, desktop, laptop, a personal digital assistant (PDA) or other computing device. The workstation 100 is accessible to the user 102 and provides a computing platform for various applications.

The workstation 100 can include a display 104. The display 104 can be physical equipment that displays viewable images and text generated by the workstation 100. For example, the display 104 can be a cathode ray tube or a flat panel display such as a TFT LCD. The display 104 includes a display surface, circuitry to generate a picture from electronic signals sent by the workstation 100, and an enclosure or case. The display 104 can interface with an input/output interface 110, which translate data from the workstation 100 to signals for the display 104.

The workstation 100 may include one or more output devices 106. The output device 106 can be hardware used to communicate outputs to the user. For example, the output device 106 can include speakers and printers, in addition to the display 104 discussed above.

The workstation 100 may include one or more input devices 108. The input device 108 can be any computer hardware used to translate inputs received from the user 102 into data usable by the workstation 100. The input device 108 can be keyboards, mouse pointer devices, microphones, scanners, video and digital cameras, etc.

The workstation 100 includes an input/output interface 110. The input/output interface 110 can include logic and physical ports used to connect and control peripheral devices, such as output devices 106 and input devices 108. For example, the input/output interface 110 can allow input and output devices 106 and 108 to be connected to the workstation 100.

The workstation 100 includes a network interface 112. The network interface 112 includes logic and physical ports used to connect to one or more networks. For example, the network interface 112 can accept a physical network connection and interface between the network and the workstation by translating communications between the two. Example networks can include Ethernet, the Internet, or other physical network infrastructure. Alternatively, the network interface 112 can be configured to interface with a wireless network. Alternatively, the workstation 100 can include multiple network interfaces for interfacing with multiple networks.

The workstation 100 communicates with a network 114 via the network interface 112. The network 114 can be any network configured to carry digital information. For example, the network 114 can be an Ethernet network, the Internet, a wireless network, a cellular data network, or any Local Area Network or Wide Area Network.

The workstation 100 includes a central processing unit (CPU) 118. The CPU 118 can be an integrated circuit configured for mass-production and suited for a variety of computing applications. The CPU 118 can be installed on a motherboard within the workstation 100 and control other workstation components. The CPU 118 can communicate with the other workstation components via a bus, a physical interchange, or other communication channel.

In one embodiment, the workstation 100 can include one or more graphics processing units (GPU) or other video accelerating hardware.

The workstation 100 includes a memory 120. The memory 120 can include volatile and non-volatile memory accessible to the CPU 118. The memory can be random access and store data required by the CPU 118 to execute installed applications. In an alternative, the CPU 118 can include on-board cache memory for faster performance.

The workstation 100 includes mass storage 122. The mass storage 122 can be volatile or non-volatile storage configured to store large amounts of data. The mass storage 122 can be accessible to the CPU 118 via a bus, a physical interchange, or other communication channel. For example, the mass storage 122 can be a hard drive, a RAID array, flash memory, CD-ROMs, DVDs, HD-DVD or Blu-Ray mediums.

The workstation 100 can include render instructions 124 stored in the memory 120. As discussed below, the workstation 100 can receive 3D mesh objects for rendering into animation sequences. The render instructions 124 can execute on the CPU 118 to provide the rendering function. The rendered animation sequences can be displayed on the display 104 and cached in the memory 120 for later use, as discussed below.

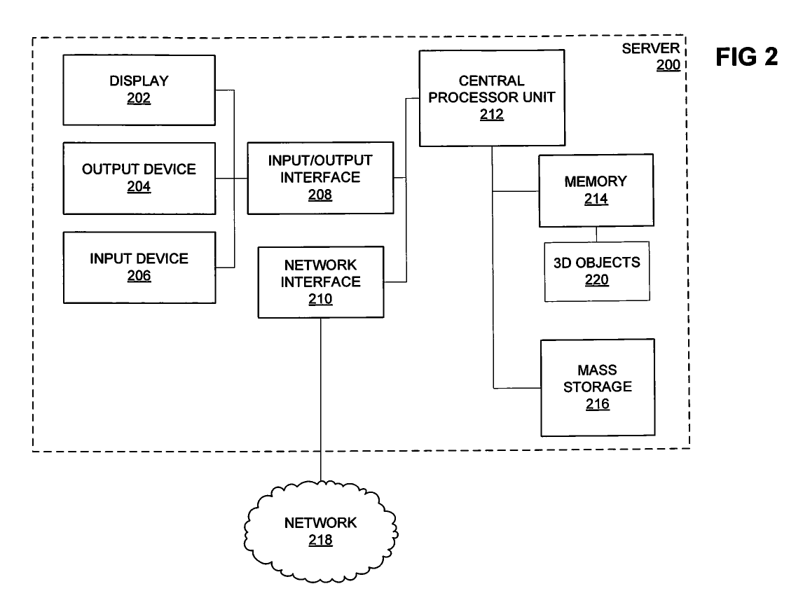

FIG. 2 illustrates an example server for improved rendering of 3D objects. A server 200 is configured to execute an application for providing a virtual world to one or more workstations, as illustrated in FIG. 1. For example, the server 200 can be a server configured to communicate over a plurality of networks. Alternatively, the server 200 can be any computing device.

The server 200 includes a display 202. The display 202 can be equipment that displays viewable images, graphics, and text generated by the server 200 to a user. For example, the display 202 can be a cathode ray tube or a flat panel display such as a TFT LCD. The display 202 includes a display surface, circuitry to generate a viewable picture from electronic signals sent by the server 200, and an enclosure or case. The display 202 can interface with an input/output interface 208, which converts data from a central processor unit 212 to a format compatible with the display 202.

The server 200 includes one or more output devices 204. The output device 204 can be any hardware used to communicate outputs to the user. For example, the output device 204 can be audio speakers and printers or other devices for providing output.

The server 200 includes one or more input devices 206. The input device 206 can be any computer hardware used to receive inputs from the user. The input device 206 can include keyboards, mouse pointer devices, microphones, scanners, video and digital cameras, etc.

The server 200 includes an input/output interface 208. The input/output interface 208 can include logic and physical ports used to connect and control peripheral devices, such as output devices 204 and input devices 206. For example, the input/output interface 208 can allow input and output devices 204 and 206 to communicate with the server 200.

The server 200 includes a network interface 210. The network interface 210 includes logic and physical ports used to connect to one or more networks. For example, the network interface 210 can accept a physical network connection and interface between the network and the workstation by translating communications between the two. Example networks can include Ethernet, the Internet, or other physical network infrastructure. Alternatively, the network interface 210 can be configured to interface with wireless network. Alternatively, the server 200 can include multiple network interfaces for interfacing with multiple networks.

The server 200 includes a central processing unit (CPU) 212. The CPU 212 can be an integrated circuit configured for mass-production and suited for a variety of computing applications. The CPU 212 can sit on a motherboard within the server 200 and control other workstation components. The CPU 212 can communicate with the other workstation components via a bus, a physical interchange, or other communication channel.

The server 200 includes memory 214. The memory 214 can include volatile and non-volatile memory accessible to the CPU 212. The memory can be random access and provide fast access for graphics-related or other calculations. In one embodiment, the CPU 212 can include on-board cache memory for faster performance.

The server 200 includes mass storage 216. The mass storage 216 can be volatile or non-volatile storage configured to store large amounts of data. The mass storage 216 can be accessible to the CPU 212 via a bus, a physical interchange, or other communication channel. For example, the mass storage 216 can be a hard drive, a RAID array, flash memory, CD-ROMs, DVDs, HD-DVD or Blu-Ray mediums.

The server 200 communicates with a network 218 via the network interface 210. The network 218 can be as discussed. The server 200 can communicate with a mobile device over the cellular network 218.

Alternatively, the network interface 210 can communicate over any network configured to carry digital information. For example, the network interface 210 can communicate over an Ethernet network, the Internet, a wireless network, a cellular data network, or any Local Area Network or Wide Area Network.

The server 200 can include 3D objects 220 stored in the memory 214. For example, the 3D objects 220 can be 3D mesh objects, as discussed below. The 3D objects 220 can be created by a virtual world administrator or created and saved on the server 200 for later transmission to workstations. The 3D objects 220 can each be associated with one or more animation sequences when rendered for display at a workstation.

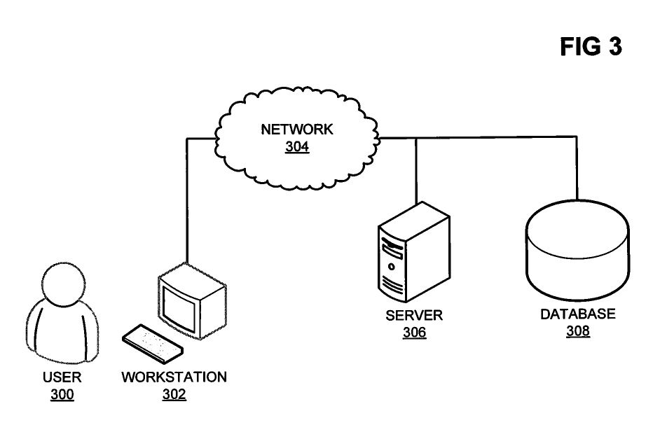

FIG. 3 illustrates an example system for improved rendering of 3D objects. A user 300 can use a user interface provided by a workstation 302 to interact with a virtual world provided by a server 306.

The workstation 302 can be as illustrated in FIG. 1. It will be appreciated the functionality of the workstation 302 can be distributed among a combination of a server as illustrated in FIG. 2, a workstation, a mobile device, or any combination of computing devices. It will be appreciated that any number of users and workstation can exist in the system, communicating with the server 306 over the network 304.

The network 304 can be configured to carry digital information, as discussed above. Digital information can include 3D mesh objects transmitted to the workstation 302, as discussed above.

The server 306 can be as illustrated in FIG. 2. It will be appreciated that any number of servers can exist in the system, for example, distributed geographically to improve performance and redundancy.

The system can include a database 308 configured to store necessary data. For example, the 3D objects can be stored in the database 308, separate from the server 306, for improved performance and reliability. It will be appreciated that any number of databases can exist in the system.

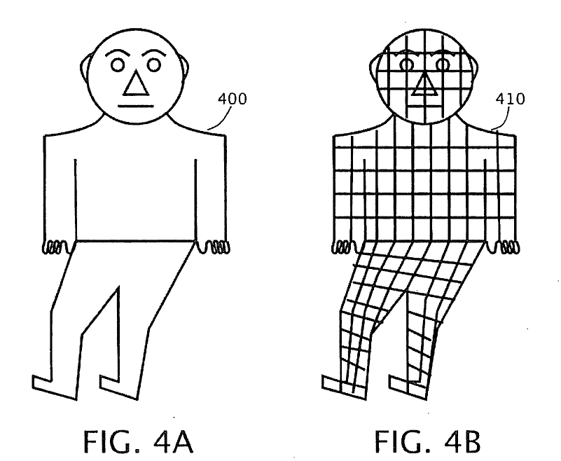

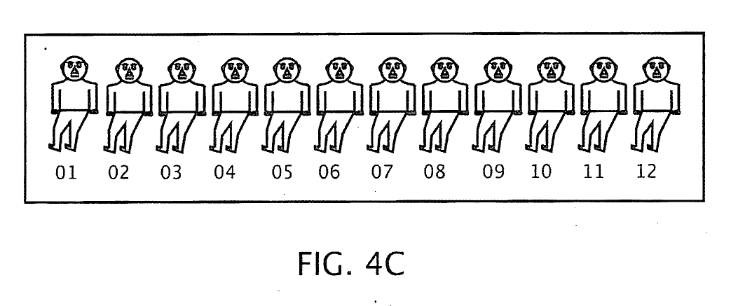

FIG. 4A illustrates an example rendered 3D object 400. For example, the 3D object can be rendered from a 3D mesh object as illustrated in FIG. 4B. As illustrated, the rendered 3D object 400 can be an avatar in a virtual world provided by a server. The rendering can be performed at a workstation as illustrated above.

FIG. 4B illustrates an example 3D mesh object 410. The 3D mesh object can be rendered into a rendered 3D object, as illustrated in FIG. 4A. The 3D mesh object can be stored at a server or database and transmitted to a workstation on demand, as discussed above.

FIG. 4C illustrates an example animation sequence 420. The animation sequence 420 can be a walk cycle of a 3D model, as represented by the 3D mesh object illustrated in FIG. 4B. The animation sequence 420 has twelve frames of the walk cycle as 2D sprites. The 2D sprites are stored in memory for the walk animation of the character. After the animation sequence is played the first time, all subsequent cycles are played from memory using the 3D sprites. Thus, no further rendering is required.

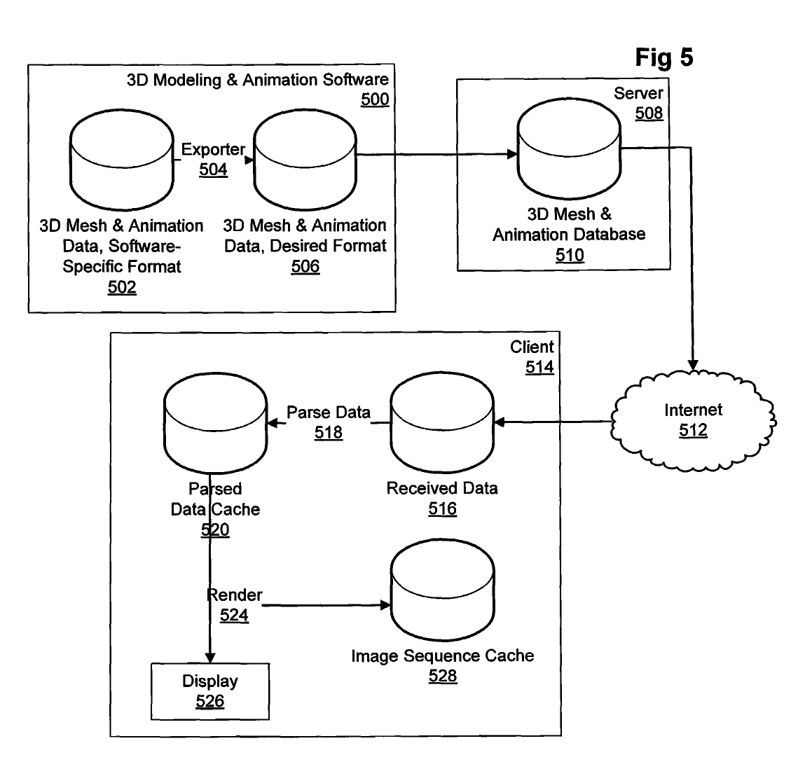

FIG. 5 illustrates an example system flow for improved rendering of 3D objects. The system can include a client, a server, and a network such as the Internet. The system can provide a virtual world to a user.

A 3D modeling and animation tool 500 (such as 3D Studio Max, XSI Softimage, Maya) can be used to create a 3D object, including a 3D mesh object and animation data. The 3D object can be initially created in a software-specific format 502, such as Collada, Cal3D, Md5, etc, or a custom format.

An exporter plug-in 504 can be used to convert the software-specific format 502 into a desired 3D format 506. For example, the desired 3D format 506 can be compatible with a specific 3D software, a graphics library for rendering on the platform of user's choice (such as Papervision3D, Away3D or Sandy for Flash; OpenGL, DirectX for Windows, etc ), and importing code for the specified 3D format in the chosen programming language.

Once the 3D modelling and animation software have been prepared by an artist using 3D modelling and animation software, they are exported to a 3D data format with a suitable plug-in. It can be preferable to have a binary 3D format for smaller data size, and it is preferably a hierarchical skeleton-based format to facilitate interchange between different models of similar skeletons.

The 3D meshes and animation are made available at a server 508 and stored in a database 510. The server 508 can be accessible via the Internet 512.

A client 514 can request a 3D object from the server 508. Once received data 516 has been received, it is parsed 518 with importing code relevant to the 3D data format. The parsed data is cached at 520 for future use. Parsing requires CPU resources. Thus, caching is necessary to avoid re-parsing the same data in the future.

The client 514 stores image arrays in the main memory specific to each animated object in each fixed angle. It always uses these arrays to display the object in the current camera angle. The rendering 524 routines hold parsed 3D data in a render queue with unique keys, and they fill the image arrays with rendered images of objects.

When an object is to be displayed on display 526, the client 214 first checks if its relevant image array has necessary frames, and if all frames are not rendered completely, the object's animation sequence in the specified fixed angle is added to the render queue. The frames are shown as rendered. Therefore, the application user does not wait for the objects' pre-rendering and does not notice the render process provided the number of concurrent render objects are below CPU computational limits.

After first rendering of an object's animation in a fixed angle, the same object (with the same animation and the same camera angle) is always displayed using the image arrays from the memory.

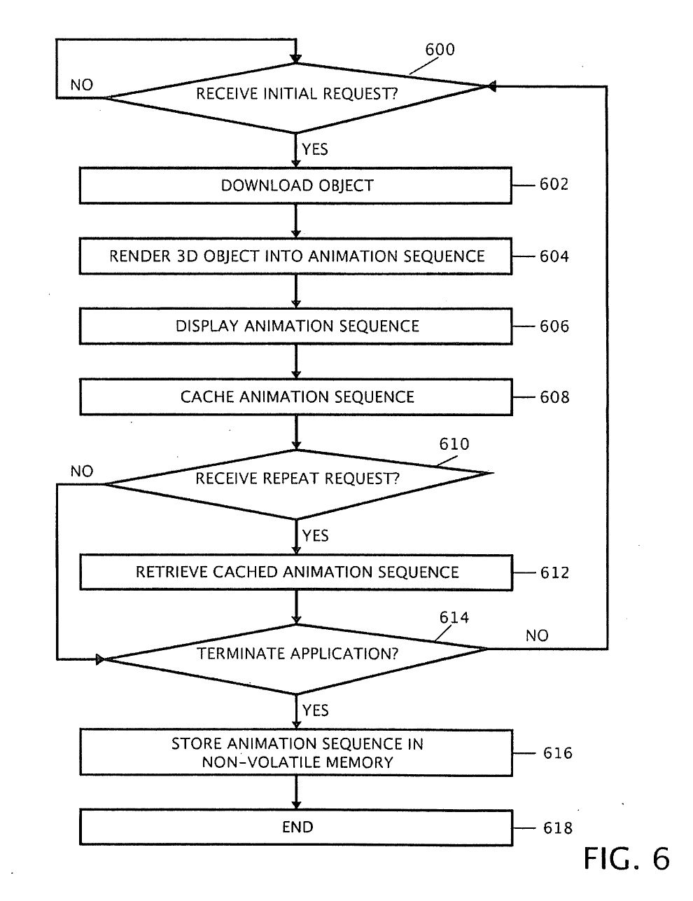

FIG. 6 illustrates an example client procedure for improved rendering of 3D objects. The procedure can execute on a workstation executing a client application for interfacing with a server, as illustrated in FIG. 1.

In 600, the client tests whether an initial request for a 3D object has been received. For example, the client can display a virtual world to the user, and request 3D objects (avatars) as appropriate while the user interacts with the virtual world.

For example, the client can maintain a list of which 3D objects have already been requested. In this example, each 3D object can be associated with a unique identifier. To determine whether a 3D object has already been requested, the client simply determines whether the 3D object's identifier is in the list.

If an initial request for the 3D object has been received, the client proceeds to 602. If no initial request has been received, the client remains at 600.

In 602, the client transmits a request for the 3D object to a server, and downloads the 3D object from the server. For example, the 3D object can be a 3D mesh object, as illustrated above. In one embodiment, the 3D object can be stored in a database, and downloaded directly from the database. For example, the 3D object can be as illustrated in FIG. 4B.

In 604, the client renders the 3D object into an animation sequence. The rendering process can be performed by the client as discussed above.

In 606, the client displays the animation sequence. The animation sequence can be part of the virtual world that the user is interacting with. For example, the animation sequence can be as illustrated in FIG. 4C.

In 608, the client caches the animation sequence rendered in 604. For example, the animation sequence can be cached in local memory by the client for later retrieval. The client can also update a table to indicate the animation sequence is stored in memory.

It will be appreciated that 606 and 608 can be performed simultaneously or in any order.

In 610, the client tests whether a repeat request for the 3D object has been received. For example, the client can determine whether the 3D object's identifier is already in memory, as discussed above.

If the client received a repeat request, the client proceeds to 612. If no repeat request was received, the client proceeds to 614.

In 612, the client retrieves the cached animation sequence associated with the requested 3D object. No downloading of the 3D object or rendering is required because the animation sequence is already available.

In 614, the client optionally tests whether the application will be terminated. For example, the application can be terminated responsive to a user indication to exit the client.

If the application will be terminated, the client proceeds to 616. If the application will not be terminated, the client can proceed to 600.

In 616, the client optionally stores all cached animation sequences into non-volatile memory, such as a hard disk. In one embodiment, the client will load all saved animation sequences into local memory at startup, improving rendering performance of a subsequent session.

In 618, the client exits the procedure.

As discussed above, one example embodiment of the present invention is a method for improving rendering performance. The method includes, responsive to an initial request for a first animation sequence at a client, downloading a first 3D object from a server. The method includes rendering the first 3D object into the first animation sequence. The method includes displaying the first animation sequence to a user. The method includes caching the first animation sequence in an accessible memory. The method includes responsive to a repeat request for the first animation sequence, retrieving the cached first animation sequence from the accessible memory. The initial request and the repeat request can be made by a 3D application executing on the client in communications with the server. The first animation sequence can be looped. The method includes storing the first animation sequence in a non-volatile memory prior to terminating the 3D application. The 3D application can provide access to a virtual world. The 3D object can be an avatar. A background of the virtual world can be a fixed 32-bit image. The first 3D object and the first animation sequence are associated with a first identifier when stored in the accessible memory. The method includes, responsive to an initial request for a second animation sequence at the client, downloading a second 3D object from the server. The method includes rendering the second 3D object into the second animation sequence. The method includes displaying the second animation sequence. The method includes caching the second animation sequence in the accessible memory. The method includes, responsive to a repeat request for the second animation sequence, retrieving the cached second animation sequence from the accessible memory.

Another example embodiment of the present invention is a client system for providing improving rendering performance. The system includes a network interface for communications with a server over a network. The system includes an accessible memory for storing a first animation sequence. The system includes a processor. The processor is configured to, responsive to an initial request for the first animation sequence, download a first 3D object from the server. The processor is configured to render the first 3D object into the first animation sequence. The processor is configured to display the first animation sequence to a user. The processor is configured to cache the first animation sequence in an accessible memory. The processor is configured to, responsive to a repeat request for the first animation sequence, retrieve the cached first animation sequence from the accessible memory. The initial request and the repeat request can be made by a 3D application executing on the client system. The first animation sequence can be looped. The system includes a non-volatile memory, in which the first animation sequence is stored prior to terminating the 3D application. The 3D application can provide access to a virtual world. The 3D object can be an avatar. A background of the virtual world can be a fixed 32-bit image. The first 3D object and the first animation sequence can be associated with a first identifier when stored in the accessible memory. The processor is configured to, responsive to an initial request for a second animation sequence, download a second 3D object from the server. The processor is configured to render the second 3D object into the second animation sequence. The processor is configured to display second first animation sequence to the user. The processor is configured to cache the second animation sequence in the accessible memory. The processor is configured to, responsive to a repeat request for the second animation sequence, retrieve the cached second animation sequence from the accessible memory.

Another example embodiment of the present invention is a computer-readable medium including instructions adapted to execute a method for improving rendering performance. The method includes, responsive to an initial request for a first animation sequence at a client, downloading a first 3D object from a server. The method includes rendering the first 3D object into the first animation sequence. The method includes displaying the first animation sequence to a user. The method includes caching the first animation sequence in an accessible memory. The method includes responsive to a repeat request for the first animation sequence, retrieving the cached first animation sequence from the accessible memory. The initial request and the repeat request can be made by a 3D application executing on the client in communications with the server. The first animation sequence can be looped. The method includes storing the first animation sequence in a non-volatile memory prior to terminating the 3D application. The 3D application can provide access to a virtual world. The 3D object can be an avatar. A background of the virtual world can be a fixed 32-bit image. The first 3D object and the first animation sequence are associated with a first identifier when stored in the accessible memory. The method includes, responsive to an initial request for a second animation sequence at the client, downloading a second 3D object from the server. The method includes rendering the second 3D object into the second animation sequence. The method includes displaying the second animation sequence. The method includes caching the second animation sequence in the accessible memory. The method includes, responsive to a repeat request for the second animation sequence, retrieving the cached second animation sequence from the accessible memory.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A method for improving rendering performance, comprising:
responsive to an initial request for a first animation sequence at a client, downloading a first 3D object from a server;
rendering the first 3D object into the first animation sequence;
displaying the first animation sequence to a user;
caching the first animation sequence in an accessible memory; and
responsive to a repeat request for the first animation sequence, retrieving the cached first animation sequence from the accessible memory.

2. The method of claim 1, wherein the initial request and the repeat request are made by a 3D application executing on the client in communications with the server.

3. The method of claim 2, wherein the first animation sequence is looped.

4. The method of claim 2, further comprising:
storing the first animation sequence in a non-volatile memory prior to terminating the 3D application.

5. The method of claim 2, wherein,
the 3D application provides access to a virtual world,
the 3D object is an avatar, and
a background of the virtual world is a fixed 32-bit image.

6. The method of claim 1, wherein the first 3D object and the first animation sequence are associated with a first identifier when stored in the accessible memory.

7. The method of claim 1, further comprising:
responsive to an initial request for a second animation sequence at the client, downloading a second 3D object from the server;
rendering the second 3D object into the second animation sequence;
displaying the second animation sequence;
caching the second animation sequence in the accessible memory; and
responsive to a repeat request for the second animation sequence, retrieving the cached second animation sequence from the accessible memory.

8. A client system for providing improving rendering performance, comprising:
a network interface for communications with a server over a network;
an accessible memory for storing a first animation sequence; and
a processor, the processor configured to,
responsive to an initial request for the first animation sequence, download a first 3D object from the server,
render the first 3D object into the first animation sequence,
display the first animation sequence to a user,
cache the first animation sequence in an accessible memory, and
responsive to a repeat request for the first animation sequence, retrieve the cached first animation sequence from the accessible memory.

9. The system of claim 8, wherein the initial request and the repeat request are made by a 3D application executing on the client system.

10. The system of claim 9, wherein the first animation sequence is looped.

11. The system of claim 9, further comprising:
a non-volatile memory, in which the first animation sequence is stored prior to terminating the 3D application.

12. The system of claim 9, wherein,
the 3D application provides access to a virtual world,
the 3D object is an avatar, and
a background of the virtual world is a fixed 32-bit image.

13. The system of claim 8, wherein the first 3D object and the first animation sequence are associated with a first identifier when stored in the accessible memory.

14. The system of claim 8, the processor further configured to,
responsive to an initial request for a second animation sequence, download a second 3D object from the server,
render the second 3D object into the second animation sequence,
display second first animation sequence to the user,
cache the second animation sequence in the accessible memory, and responsive to a repeat request for the second animation sequence, retrieve the cached second animation sequence from the accessible memory.

15. A computer-readable medium including instructions adapted to execute a method for improving rendering performance, the method comprising:
responsive to an initial request for a first animation sequence at a client, downloading a first 3D object from a server;
rendering the first 3D object into the first animation sequence;
displaying the first animation sequence to a user;
caching the first animation sequence in an accessible memory; and
responsive to a repeat request for the first animation sequence, retrieving the cached first animation sequence from the accessible memory.

16. The medium of claim 15, wherein the initial request and the repeat request are made by a 3D application executing on the client in communications with the server.

17. The medium of claim 16, the method further comprising:
storing the first animation sequence in a non-volatile memory prior to terminating the 3D application.

18. The medium of claim 16, wherein,
the first animation sequence is looped,
the 3D application provides access to a virtual world,
the 3D object is an avatar in the virtual world, and
a background of the virtual world is a fixed 32-bit image.

19. The medium of claim 15, wherein the first 3D object and the first animation sequence are associated with a first identifier when stored in the accessible memory.

20. The medium of claim 15, further method comprising:
responsive to an initial request for a second animation sequence at the client, downloading a second 3D object from the server;
rendering the second 3D object into the second animation sequence;
displaying the second animation sequence;
caching the second animation sequence in the accessible memory; and
responsive to a repeat request for the second animation sequence, retrieving the cached second animation sequence from the accessible memory.
